(19) United States
(12) Patent Application Publication
(10) Pub. No.: US 2006/0273528 A1
(43) Pub. Date: Dec. 7, 2006

(54) Bellows for articulated joints

(75) Inventor: Stefan Schirmer, Lehrte (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 11/444,568

(22) Filed: Jun. 1, 2006

(30) Foreign Application Priority Data
Jun. 1, 2005 (EP) EP 05011784.5

(51) Int. Cl. F16J 15/52; F16J 3/00

(52) U.S. Cl. 277/635

(57) ABSTRACT

A bellows having a substructure including a first end and a second end, the ends being movable relative to one another, circumferential bulges, which are spaced apart by first constricted regions, being formed in the substructure between the ends, and a second constricted region being formed in at least one bulge. The width of the second constricted region corresponds at least to its height in order to reduce the axial stiffness and increase the radial stiffness.

This application claims the benefit of European Patent Application No. 05 011 784.5 filed Jun. 1, 2005 and hereby incorporated by reference herein.

The present invention relates to a bellows having a substructure including a first end and a second end, the ends being movable relative to one another, circumferential bulges, which are spaced apart by first constricted regions, being formed in the substructure between the ends, and a second constricted region being formed in at least one bulge.

### BACKGROUND INFORMATION

Bellows of this kind are already known from the related art. The German Patent Application No. DE 25 05 542 A1 describes a bellows of the type described, whose second constricted regions extend in a very flat and wide form. Bellows of this type are frequently assigned to articulated joints, in particular to articulated joints for drive shafts of motor vehicles. The bellows have load-bearing capacity both in the axial, as well as in the radial directions. The folds of such a bellows are elongated on one side and compressed on another side during operation in response to deflection of the articulated joint. In the process, high compressive stresses occur in the outer regions assigned to a fold apex. They produce strain, which can cause the folds to buckle. This buckling is typically associated with destruction of the bellows. In particular, the buckling can cause the outwardly curved fold hills to be forced inwards.

The known bellows are not capable of countering these load moments in a satisfactory manner. The folds could be prevented from buckling or collapsing by increasing the moment of resistance thereof. To this end, it is conceivable to increase the wall thicknesses of the substructure. At the same time, however, it is necessary to reduce the resistance of the folds to elongation and compression processes. In particular, it is necessary to reduce the axial stiffness of a bellows and thereby enhance the elasticity with respect to this degree of freedom. On the other hand, the radial stiffness must be clearly increased in order to prevent collapsing up to a specific load.

Generic bellows are precluded by their structural design from having such dynamic properties.

### SUMMARY OF THE INVENTION

An object of the present invention is, therefore, to design and further refine a bellows in a way that will reduce the axial stiffness and enhance the radial stiffness.

The present invention provides a bellows having a substructure including a first end and and a second end, the ends being movable relative to one another, circumferential bulges, which are spaced apart by first constricted regions, being formed in the substructure between the ends, and a second constricted region being formed in at least one bulge, characterized in that the width of the second constricted region corresponds at most to its depth. It is a realization of the present invention that a flat constricted region does not reduce or hardly reduces the axial stiffness of a bellows. It is also a realization that the radial stiffness is not enhanced or is hardly enhanced by a flat constricted region. In a second step, the realization is made that the axial stiffness of a bellows may be perceptibly reduced and the radial stiffness thereof may be distinctly enhanced by the provision of a constricted region having an elongated form. Finally, the realization is made in a third step that the bellows' moment of resistance to buckling or collapsing may be enhanced without increasing the wall thicknesses by selecting the geometry of the constricted region in accordance with the present invention.

In one embodiment that is especially favorable in terms of structural design, the second constricted regions may be bounded by two ridges. This increases the resistance to buckling. At the same time, the ridges reduce the resistance to such deformations in the direction of compression and elongation. In this context, it is conceivable for the ridges to be provided on all of the second constricted regions or only on individual constricted regions.

The first and the second constricted regions may be disposed concentrically. In this connection, it is conceivable, in particular, that the first constricted regions have a smaller circumference than the second constricted regions. This specific embodiment ensures a symmetric design of the bellows which is manifested in an advantageous dynamics of motion.

The width of the second constricted regions may be smaller than the wall thickness of the substructure. In this embodiment, the realization is made that the second constricted regions function quasi as predetermined pressure-relief or yield-to-buckling joints, which advantageously relieve the substructure. This ensures a long service life and a defined load-bearing capacity for the bellows.

The second constricted regions may have a width of one millimeter at most. This embodiment ensures that there is only very little disturbance to the homogeneity of the substructure surface. In addition, the advantageous realization is made that dirt contamination is only able to accumulate to a very slight degree in the constricted regions.

The depth of the second constricted regions may be greater or equal to the wall thickness of the substructure. This embodiment ensures that, relative to the wall material, the second constricted regions constitute an elongated recess which clearly reduces the axial stiffness. In this respect, the dimension of the second constricted region has a decided effect on the stiffness characteristics. In this context, the second constricted regions may have a depth of 1 to 2 mm. Such a dimensioning is particularly advantageous when the substructure is fabricated from a thermoplastic elastomer. Due to their material structure, thermoplastic elastomers may be modified very advantageously with respect to their stiffness by constricted regions of the mentioned dimensioning.

The second constricted regions may be formed in the area of the outermost circumference of the bulges. It is conceivable, in particular, for the constricted regions to be positioned in the middle of the bulges, dividing the same quasi into two segments. This specific embodiment allows the segments to move relative to one another and to be free of peak loads caused by compression or elongation of the bellows. The second constricted regions may have a triangular cross section. The triangular shape advantageously forms two sides which are movable relative to each other very effectively in terms of force response. In this respect, the constricted region imparts special elastic properties to the bellows. The second constricted regions may have a rectangular cross section. This embodiment is characterized by ease of production since rectangular elements are easily removed from the mold during demolding processes.

The second constricted regions may have a trapezoidal cross section. The trapezoidal shape also facilitates removal of a workpiece from a mold. Moreover, trapezoidal-shaped constricted regions are readily cleaned of dirt contamination since they have an outwardly opening form.

The second constricted regions may have a rhombic cross section. This embodiment ensures that no dirt particles are able to penetrate into the interior of the constricted region, since the rhombic shape has only a small gap.

The second constricted regions may have a polygonal cross section. In this context, the number of angles may be selected as a function of the desired elasticity.

The second constricted regions may have a semicircular cross section. A semicircle is realized by a constricted region whose width is equal to its depth. In addition, it allows a light cleaning of the constricted region, since it opens outwardly in a sickle shape and is thus easily accessible.

The second constricted regions may have an elliptical, parabolic or hyperbolical cross section. These special embodiments may be selected entirely as a function of the deformation behavior requirements of the bellows. An especially high degree of stiffness is realized in the radial direction by an ellipse, less stiffness in the radial direction by a paraboloid, and an intermediate degree of stiffness by a hyperboloid.

The constricted regions may have undercuts. The formation of undercuts is advantageous to prevent load peaks in the constricted regions. This prolongs the service life of the bellows.

Rounded edges may be formed in or on the constricted regions. The formation of rounded edges also ensures that the material of the substructure is not subjected to any peak loads during dynamic processes. In this respect, material fatigue and increased wear are effectively avoided.

The substructure may have an axially symmetric design. This embodiment permits an especially problem-free manufacture of the substructure.

The ends of the substructure may be formed as ends of an axial passage. The ends may have a cylindrical design. This specific embodiment makes it possible to assign the bellows to cylindrical elements such as shafts or rods. In this context, an articulated joint located between two rods or shafts is accommodated on the inside of the substructure.

The substructure may have a frustoconical design, at least in portions thereof. The tapering of the truncated cone may be selected as a function of those angles that may be subtended by the rods joined by an articulated joint. Thus, through taper selection, it is possible to advantageously adjust the compression or elongation load the substructure is subjected to.

### BRIEF DESCRIPTION OF THE DRAWINGS

The teaching of the present invention may be advantageously embodied and further refined in different ways. In conjunction with the explanation of the preferred exemplary embodiments of the present invention which makes reference to the drawings, generally preferred embodiments and refinements of the teaching are also elucidated in which:

FIG. 1: shows a bellows, which has bulges having constricted regions;

FIG. 2: shows a bulge having a second constricted region that is triangular in cross section;

FIG. 3: shows a constricted region that is rectangular in cross section;

FIG. 4: shows a constricted region that is trapezoidal in cross section;

FIG. 5: shows a constricted region that is rhombic in cross section;

FIG. 6: shows a constricted region that is polygonal in cross section;

FIG. 7: shows a constricted region that is semicircular in cross section;

FIG. 8: shows a constricted region that is elliptical in cross section;

FIG. 9: shows a constricted region that is hyperbolical in cross section;

FIG. 10: shows a constricted region that is symmetrically polygonal in cross section; and

FIG. 11: shows a constricted region that is parabolic in cross section.

### DETAILED DESCRIPTION

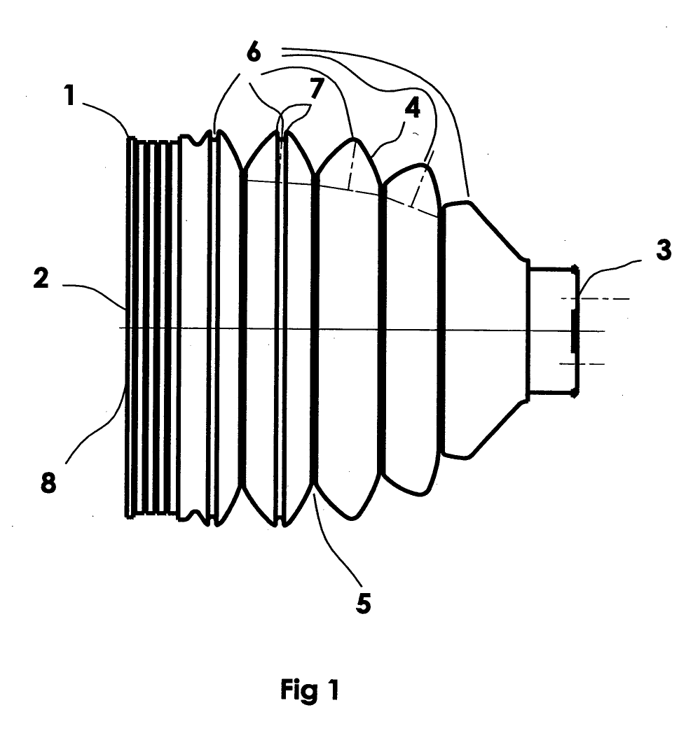

FIG. 1 shows a bellows having a substructure 1 including a first end 2 and a second end 3, ends 2, 3 being movable relative to one another, circumferential bulges 4, which are spaced apart by first constricted regions 5, being formed in substructure 1 between the ends, and a second constricted region 6 being formed in at least one bulge 4. The width of second constricted region 6 has a value that corresponds at most to the value of its depth. Second constricted regions 6 are bounded by two ridges 7. First constricted regions 5 and second constricted regions 6 are disposed concentrically about an axis extending through ends 2, 3. Second constricted regions 6 are formed in the area of the outermost circumference of bulges 4.

Substructure 1 has an axially symmetric design. Ends 2, 3 are formed as ends 2, 3 of an axial passage 8 in substructure 1. Substructure 1 has a frustoconical design, at least in portions thereof.

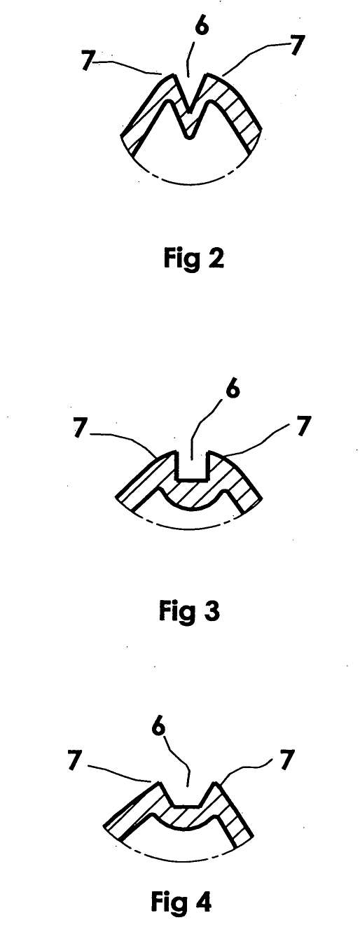

FIG. 2 shows a second constricted region that is triangular in cross section.

FIG. 3 shows a second constricted region that is rectangular in cross section.

FIG. 4 shows a second constricted region that is trapezoidal in cross section.

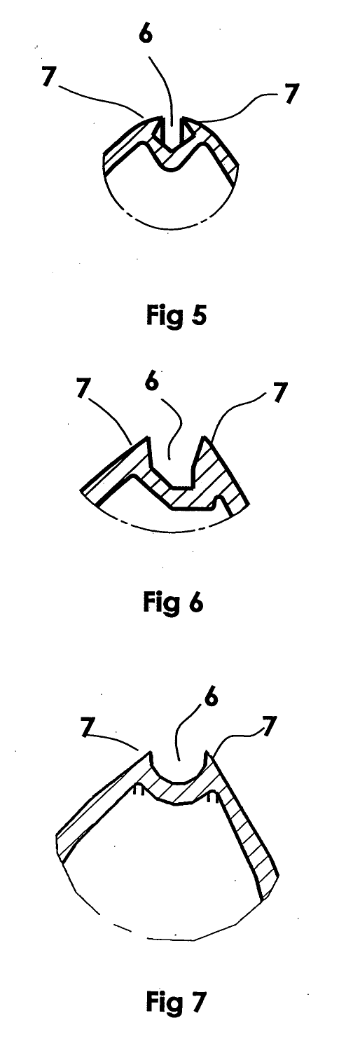

FIG. 5 shows a second constricted region 6 that is rhombic in cross section.

FIG. 6 and FIG. 10 each show a second constricted region 6 that is polygonal in cross section.

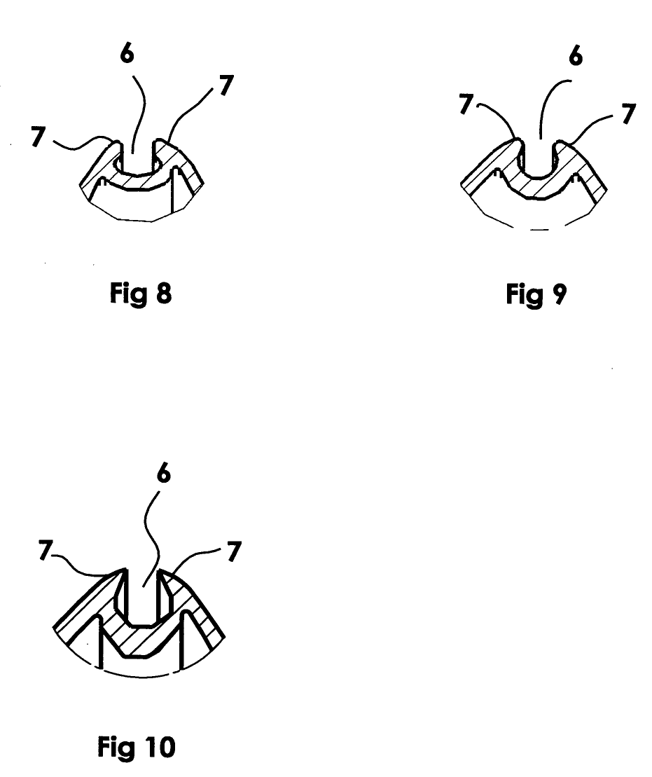

FIG. 7 shows a second constricted region 6 that is semicircular in cross section, having two pointed ridges 7.

FIG. 8 shows a second constricted region 6 that is elliptical in cross section and that has two ridges 7.

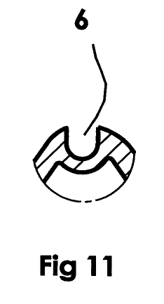

FIG. 9 shows a second constricted region 6 that is hyperbolical in cross section and that has two ridges 7.

FIG. 10 shows a second constricted region 6 that is symmetrically polygonal in cross section.

FIG. 11 shows a second constricted region 6 that is designed to be parabolic in cross section.

With regard to other advantageous embodiments and refinements of the teaching of the present invention, reference is made, on the one hand, to the general portion of the specification and, on the other hand, to the appended claims.

Finally, it is especially emphasized that the above exemplary embodiments, are merely intended for purposes of discussing the teaching of the present invention, but not for limiting it to such exemplary embodiments. It is noted that the Figures are for illustrative purposes only and that for example the width of the opening between ridges 7 in the FIGS. 4 and 7 embodiments is less than or equal to the depth from the top of the ridge to the deepest part of the opening.

What is claimed is:

1. A bellows comprising:
a substructure including:
a first end;
a second end; the second end movable relative to the first end; and
circumferential bulges, between the first and second ends;
circumferential bulges being spaced apart by first constricted regions; and
at least one circumferential bulge of the circumferential bulges having a second constricted region with a depth and a width, the width being no greater than the depth.

2. The bellows as recited in claim 1 wherein the at least one circumferential bulge has two ridges bounding a second constricted region.

3. The bellows as recited in claim 1 wherein the first and the second constricted regions are disposed concentrically.

4. The bellows as recited in claim 1 wherein the width of the second constricted region is less than a wall thickness of the substructure.

5. The bellows as recited in claim 4 wherein the width of the second constricted region is 1 mm or less.

6. The bellows as recited in claim 1 wherein the depth of the second constricted region is greater than or equal to a wall thickness of the substructure.

7. The bellows as recited in claim 6 wherein the depth of the second constricted region is 1 to 2 mm.

8. The bellows as recited in claim 1 wherein the second constricted region is formed in an area of an outermost circumference of the bulges.

9. The bellows as recited in claim 1 wherein the second constricted region has a triangular cross section.

10. The bellows as recited in claim 1 wherein the second constricted region has a rectangular cross section.

11. The bellows as recited in claim 1 wherein the second constricted region has a trapezoidal cross section.

12. The bellows as recited in claim 1 wherein the second constricted region has a rhombic cross section.

13. The bellows as recited in claim 1 wherein the second constricted region has a polygonal cross section.

14. The bellows as recited in claim 1 wherein the second constricted region has a semicircular cross section.

15. The bellows as recited in claim 1 wherein the second constricted region has an elliptical cross section.

16. The bellows as recited in claim 1 wherein the second constricted region has a parabolic cross section.

17. The bellows as recited in claim 1 wherein the second constricted region has a hyperbolical cross section.

18. The bellows as recited in claim 1 wherein the second constricted region has undercuts.

19. The bellows as recited in claim 1 wherein rounded edges formed in or on the second constricted region.

20. The bellows as recited in claim 1 wherein the substrate has an axially symmetric design.

21. The bellows as recited in claim 1 wherein the substructure has an axial passageway coinciding with the first and second ends.

22. The bellows as recited in claim 1 wherein the substructure is frustoconical.
